(19) United States
(12) Patent Application Publication
(10) Pub. No.: US 2011/0006887 A1
(43) Pub. Date: Jan. 13, 2011

(54) Programmable Communicating Thermostat And System

(75) Inventors: Randall L. Shaull, Granger, IN (US); Bruce D. Westphal, Elkhart, IN (US); James Robert Herdeman, Goshen, IN (US); Wayne Kehler, Goshen, IN (US)

Correspondence Address: SHEWCHUK IP SERVICES, 3356 SHERMAN CT. STE. 102, EAGAN, MN, 55121, US

(73) Assignee: KMC CONTROLS, INC., New Paris, IN (US)

(21) Appl. No.: 12/834,727

(22) Filed: Jul. 12, 2010

Related U.S. Application Data
(60) Provisional application No. 61/225,040, filed on Jul. 13, 2009.

(51) Int. Cl. G05B 11/01

(52) U.S. Cl. 340/310.11

(57) ABSTRACT

A programmable thermostat has two way communication with a utility using a power carrier line signal across distributed low voltage power lines in a building downstream of an HVAC system transformer. The two way PLC communication includes transmission to the utility of response information regarding the response taken by the thermostat to a power “shed” command, and preferably also includes sensed temperature and/or temperature set point information. The HVAC system transformer includes an integral capacitive bypass path for PLC data transmission across the windings of the transformer. The thermostat positions its temperature sensor to avoid heat given off by the PLC receiver/transmitter and its electrical circuits as well as the thermostat microprocessor and the electrical power circuits therefore.

### CROSS-REFERENCE TO RELATED APPLICATION(S)

This application claims priority from Provisional Application No. 61/225,040, filed Jul. 13, 2009, entitled PROGRAMMABLE COMMUNICATING THERMOSTAT AND SYSTEM.

### BACKGROUND OF THE INVENTION

The present invention relates to programmable thermostats, and, more particularly, to programmable thermostats and thermostat systems used in heating, ventilation and air conditioning (“HVAC”) systems for buildings which can communicate with a utility such as through using a power line communication (also known as power line carrier, hereinafter referred to as “PLC”) signal.

Increases in efficiency in utilizing energy are continuously needed, and are becoming even more important with our country's movement off of foreign-provided fossil fuels and into alternative and cleaner energy sources. One of the primary ways in which we use energy is in heating, cooling and ventilating our indoor spaces. Sometimes fossil fuels, such as natural gas, are delivered to a building for use such as in heating the indoor spaces. Other times, energy is delivered to the building using electricity; the actual source of the energy for the electricity might be a fossil fuel, but more frequently is becoming a renewable, cleaner source, such as hydroelectric, wind or solar. In either event, the utility provider of the energy often has an incentive to control the rate of energy use which competes with the desires or strategy of the building occupant.

For instance, on a hot day a building resident may wish to maximize air conditioning use to keep the indoor space as cool as possible. Air conditioners represent significant consumption of electricity. When many building occupants in a geographic area behave similarly in this regard, the peak electricity load on a hot day may be several times the average electricity load handled by a utility company. The utility's systems—indeed the entire national electronic grid—must handle significant differences in electrical loads, which adds tremendous cost. As we move toward alternative energy sources, these differences in electrical loads can be magnified, such as when the hot (increased air conditioning) weather is also still and dry (resulting in decreased supply of wind and hydroelectric power).

One conceptual strategy to reduce such costs is for the utility company to more directly influence the level of energy consumption. Some utility companies have changed pricing structures, such as charging higher prices for electricity at times of peak demand. Other utility companies have offered reduced overall pricing to consumers who will allow the utility company to curtail their energy usage at times of peak demand. Regardless of the mechanism used, the effective implementation of such a strategy presents many thorny problems. There are hundreds of different utility companies, each of which will likely want to implement slightly different strategies, and millions of different consumers having different desired responses to whatever strategy is implemented by their utility company. There are numerous pieces of equipment, made by numerous different entities, involved between the utility company and the consumer.

In an effort to come to some standardization and provide a means of addressing these problems, groups such as the California Energy Commission have set up a task force called UtilityAMI for the development of high-level guidelines and open standards for advanced metering options within a home area network. See the UtilityAMI 2008 Home Area Network System Requirements Specification provided at http://osgug.ucaiug.org/sgsystems/openhan/Shared%20Documents/UtilityAMI%20HAN%20SRS%20-%20v1.04%20-%2008 0819-1.pdf, incorporated by reference. See also U.S. Pat. No. 7,702,424, incorporated by reference. While these communication guidelines provide some level of help in allowing utility companies and HVAC equipment manufacturers to build systems which will facilitate communication, much implementation work is left to be done.

For instance, even if an open source language is adopted, there are various modes of communication which can exist between pieces of HVAC equipment. One possible mode of communication for the utility company is to communicate instructions over a PLC signal, i.e, to embed the instructions in a radio frequency (“RF”) signal transmitted over the same power lines which transmit the electricity. Devices for the generation, transmission, reception and decoding of such PLC signals are commercially provided by companies such as Bel Fuse Inc. of Jersey City, N.J. under the HOMEPLUG designation. However, the vast majority of PLC devices involve communication between a transmitter and a receiver both located within a building and made by the same company, rather than between a transmitter or receiver located a significant distance away from the building communicating with another manufacturer's device. The utility company will thus have many decisions and implementation issues to effectively generate and transmit instructions to each building where the utility seeks to influence the level of energy consumption.

To the extent that PLC signals have been contemplated for signal generation by the utility company for use within a building, HVAC equipment manufactures have generally pursued receiving a PLC signal at the electricity meter, at a main electrical junction box or at similar location for the building, and then wirelessly transmitting (such as using a ZIGBEE transmission) a related set of instructions to various pieces of equipment installed within the building. However, wireless communication presents its own set of difficulties, not the least of which is a limited distance of transmission under current FCC standards. Other systems which have considered use of a PLC signal, such as U.S. Pat. No. 4,241,345, have not specifically considered how the PLC signal would be propagated and received. Better and more cost effective systems are needed.

### BRIEF SUMMARY OF THE INVENTION

The present invention involves a utility demand response/home automation network (HAN)-standard programmable communicating thermostat, and a system utilising the programmable communicating thermostat. The thermostat receives information from a utility using a power carrier line signal using the distributed low voltage power lines downstream of an HVAC system transformer, and transmits information to the utility using the same distributed low voltage power lines. In one aspect, the HVAC system transformer includes an integral capacitive bypass path for PLC data transmission across the windings of the transformer. In another aspect, the thermostat positions its temperature sensor to avoid heat given off by the PLC receiver/transmitter and its electrical circuits as well as the microprocessor and the electrical power circuits therefore. The two-way PLC communication includes transmission to the utility of response information regarding the response taken by the thermostat to a power “shed” command, and preferably also includes sensed temperature and/or temperature set point information.

### BRIEF DESCRIPTION OF THE DRAWINGS

FIG. 1 is a schematic depiction of the use of the present invention relative to a building.

FIG. 2 is a partial schematic of the transformer and partial back view schematic of the programmable communicating thermostat of the present invention.

FIG. 3 is a simplified back view of the circuit board layout for the programmable communicating thermostat of the present invention.

While the above-identified drawing figures set forth a preferred embodiment, other embodiments of the present invention are also contemplated, some of which are noted in the discussion. In all cases, this disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION

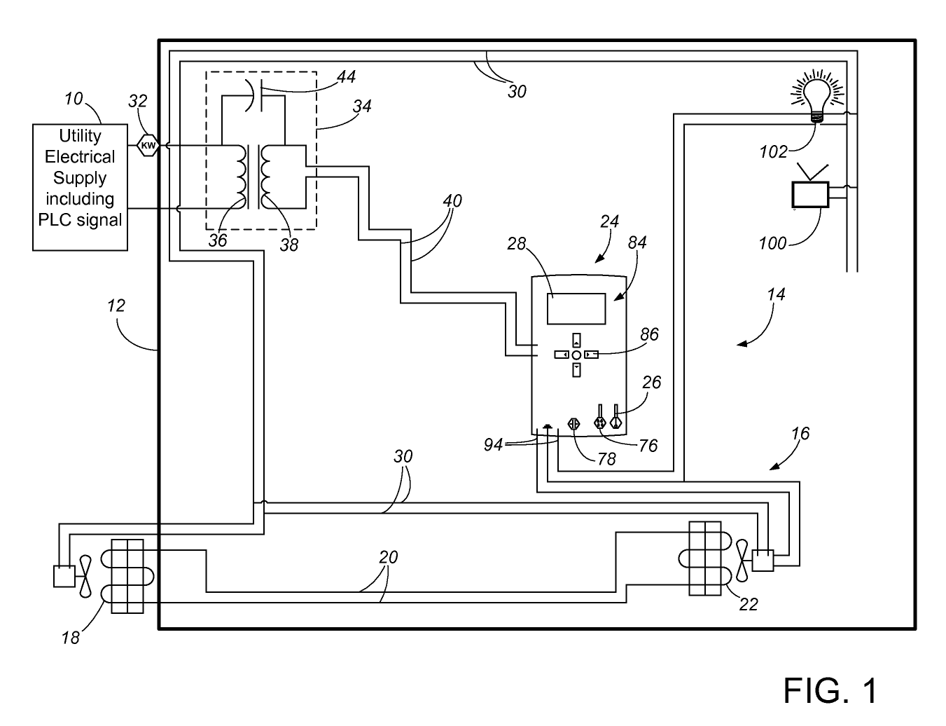

As shown in FIG. 1, the present invention involves a system in which a utility company 10 is providing energy, typically electricity, to a building 12. The building 12 uses the energy provided for various purposes, including running the heating, ventilation and air conditioning (“HVAC”) system 14 for the building 12. The HVAC system 14 includes known components of common HVAC systems, depicted in this case as a “central” air system 16 with an exterior air conditioner compressor/condenser unit 18 with refrigerant lines 20 running to an interior air conditioner evaporator/fan 22.

The air conditioner 16 is controlled by a thermostat unit 24 which includes a temperature sensor 26 to measure the temperature of air within the building 12. As typical of advanced thermostats, the thermostat 24 includes a display 28 and controls 86 to enable a building occupant to, among other functions, change the set point temperature for operation of the air conditioner 16. The thermostat 24 is located within the building 12 at a location convenient for the resident, such as on a wall centered on the main floor of the building 12, where the sensed temperature will also be representative of an average air temperature for the building 12. In prior art respects, the design of the thermostat 24 of the present invention is taken from that of the FLEXSTAT programmable thermostat of KMC Controls, Inc. of New Paris, Ind., assignee of the present invention.

Primary power for the building 12 is distributed throughout the building 12 in a standard manner, in the U.S. typically as a 120 V alternating current (60 Hz) system 30. The power consumption of the building 12 is metered by the utility company 10 with an electricity meter 32, which meter readings are used to bill the consumer for the amount of energy used. The electricity meter 32 is typically located on or near the outside of the building 12 and near a main electrical control panel or circuit breaker box (not separately shown). Typically the utility company 10 will provide similar power to numerous buildings in a geographic area.

While primary power for the building 12 is provided at 120V AC, the thermostat 24 typically is driven with a different, lower voltage power supply, such as a “Class 2” 24V AC supply. The 24V AC supply is generated by an HVAC system transformer 34 having a primary winding 36 and a secondary winding 38 which cooperate to lower the primary 120 V AC electricity to the desired 24V AC supply for the HVAC system 14. Often the transformer 34 is located a significant or “distributed” distance within the building 12 away from the thermostat 24; i.e., at a location wherein the 24V AC line 40 is run through the walls of the building 12. In some buildings the transformer may be located in a mechanical room where the primary air handling equipment (furnace, fans, etc.) is located, in other buildings the transformer may be located adjacent or in the main electrical control panel for the building.

While the occupant has primary control over the thermostat 24, the utility company 10 desires to charge the occupant at different rates or otherwise exert some influence over the amount of energy used by the building 12, particularly for lowering the amount of energy used by a collection of buildings during peak consumption or during a power shortage due to exterior, low-power-generation, conditions. For utilities which charge at different rates, the most common solutions involve a “smart meter” which communicates to the utility the amount of electricity used during shorter time periods consistent with rate changes.

However, schemes for the utility company 10 to influence the amount of energy consumed can be made more effective by utilizing information not just known by the meter 32, but also information known within the thermostat 24. Examples of such thermostat-known information are the set point temperature to activate the air conditioner 16 and the sensed air temperature, both of which are not generally known to the utility 10 or to the meter 32. Schemes for the consumer to adjust the amount of energy consumed can be made more effective by utilising real time knowledge of the pricing structure of the utility company 10, which may or may not be known within the meter 32 and is not commonly considered or known in most basic thermostat control systems.

The present invention particularly contemplates two-way communication with the utility company 10 and the thermostat 24. The present invention provides a method and device for communicating information between the thermostat 24 and the utility company 10 to effectuate more efficient and controlled use of energy within the building 12. The inventive system enables the consumer to exert flexible, set-and-forget control over the HVAC energy use without the expense of a large building automation system, while providing the utility 10 with more influence over the amount of HVAC energy use during peak usage time periods.

A first important aspect of the system is to transfer the 120V AC PLC signal to the thermostat 24. While such transfer seems simple in concept, in practice both the electrical systems of most utility companies and the electrical system within the building 12 introduce a significant amount of radio frequency noise onto the 120V AC power line 30 (only partially shown). The amount of RF noise is not so great as to defeat most PLC applications when the RF signal is generated close (i.e, within the same building) to the receiver, but becomes worse when the RF signal is generated by the utility company 10 outside the building 12.

More significantly, step-down transformers (not shown) are used to reduce the voltage transmitted by the utility company 10 down to the voltage for use by customers. PLC signals cannot readily pass through transformers, as the high inductance of the transformers makes them act as low-pass filters, substantially blocking RF signals. One way around this problem is to attach a signal repeater across each transformer. See, for instance, U.S. Pat. Nos. 7,675,408 and 7,414,518, incorporated by reference. Regardless, the present invention considers that the system used to transfer the PLC signal from the utility's transmission voltage down to the building operating voltage (typically 120 Volts, starting at least at either the meter 32 or the main electrical box) is within the control and province of the utility company 10.

Rather than using a repeater, the more common solution in the HVAC industry is to wirelessly transmit the PLC commands to the thermostat 24. However, the present invention avoids wireless transmission and reception (at least upstream of the thermostat 24) and the expense and problems inherent in such wireless transmission of the original PLC information.

A key feature of this system is thus that the thermostat 24 communicates with the utility company 10 through the class 2 wiring 40, HVAC system transformer 34, and 120V AC line 30 without additional in home wiring. In one aspect, the present invention involves the use of a capacitor 44 within the HVAC system transformer 34 to transfer the PLC signal to the thermostat 24 using the class 2 24V AC power line 40. The capacitor 44 is electrically connected across the primary winding 36 and secondary winding 38 of the HVAC system transformer 34. For instance, a 120V AC primary, 24V AC secondary transformer from Stancor Products (division of Emerson Electronics, St. Louis, Mo.) can be modified by adding the capacitor 44 across the primary winding 36 and secondary winding 38. Alternatively and more preferably for a commercial embodiment, the capacitor 44 can be added within the same housing as the windings 36, 38 of the transformer 34. The commercial embodiment of the HVAC system transformer 34 could alternatively be rated for 240V AC on the primary side. The capacitor 44 assists in analog transference (i.e., without any interpretation of the signal contents) of the PLC RF signal across the transformer 34. The integral capacitive bypass path for data transmission is particularly important when retrofitting older inexpensive HVAC systems or in applications where significant electrical noise may be present such as multi-family dwelling units.

Another significant aspect of the present invention is that the thermostat 24 communicates back to the utility 10 utilising the same 24V AC power line 40. The use of a capacitor 44 is important in the respect that the present invention contemplates transferring PLC signals in both directions, i.e., from the utility 10 to the thermostat 24 and from the thermostat 24 to the utility 10. This communication back to the utility 10 needs to occur within real time (i.e., a period measured in seconds, such as preferably less than 60 seconds and in no event more than 300 seconds) so that the utility 10 has near real-time feedback information for use in closed loop control of demand control strategies over a wide geographic area when many of these thermostats 24 are deployed. The preferred thermostat 24 communicates back to the utility 10 within about 3 seconds of responding to a utility “shed” condition.

Another advantage of using the capacitive bypass HVAC system transformer 34 is that the transformer 34 can be installed without requiring a licensed electrician to do the work. The capacitive bypass HVAC system transformer 34 may be easily and quickly installed in HVAC systems either at the factory by the original equipment manufacturer or in existing residential applications through a simple retrofit procedure.

The use of a capacitor 44 is important in another respect in that the primary winding 36 of the transformer 34 is typically only at 120V AC. Should the capacitor 44 short, the supply voltage provided to the thermostat 24 will still only be at 120V AC which can minimize the dangerous fire hazard situation which could occur if the primary winding 36 was at a higher voltage. Alternatively, one or more fuses (not shown) can be added to avoid conducting current should the capacitor 44 short; because the transformer 34 is dedicated to the 24V HVAC system line 40 for the thermostat 24, tripping the fuse does not disrupt the power supply for the rest of the building 12.

The present invention uses a high quality capacitor 44 with a low effective series resistance rated for a voltage significantly higher than the voltage on the primary winding 36, such as rated at 250V or higher when used with a 120V AC primary voltage. The capacitor 44 should have a capacitance between 50 and 10000 pico farads, and preferably a capacitance of 500 to 1000 pico farads. The high quality capacitor 44 is much less expensive than using either a two-way repeater or a wireless transmitter/receiver within the HVAC system transformer 34.

The 24V AC PLC signal can be received at the thermostat 24 and processed using commercially available components. In the preferred embodiment, a Bel Fuse HOMEPLUG Low Power SIMPLE Embedded Power Packet Module 46 is used to receive and send the PLC signal. The PLC module 46 connects into the primary circuit board 48 with a 40 pin connector 50. The PLC module 46 is capable of Internet Protocol communication data rates in excess of 1 Mbps utilising industry standard Ethernet frame conventions and messaging. The power signals and reception/transmission pairs for the PLC module 46 are routed using matched trace lengths. The PLC module 46 receives the 24V AC line 40 through an input 52 on the circuit board 48, which is then directed through a PLC conditioning circuit 54 to the PLC module 46 while separating power for the power circuits 56 of the thermostat 24. In the preferred embodiment, the PLC conditioning circuit 54 includes a 47000 pico farad capacitor 58 in parallel with a series of two 200 KOhm resistors 60, which is then directed through a 0557-7700-04 powerline signal coupler 62 from Bel Fuse of Jersey City, N.J.

The power circuits 56 on the thermostat 24 are used to reduce the incoming 24V AC supply to regulated power supplies on the circuit board 48. In the preferred embodiment this includes three regulated supplies. The power input is first is directed across a transient voltage suppressor 64 through two ELJPA220KF 22 micro-henry chip inductors 66 from Panasonic, and then to power circuits 56 identified on the circuit board 48 as REG3, REG2 and REG1. In REG3, the primary component 68 is a LM25575 step down switching regulator from National Semiconductor, generating V_{DD} of 15 V. In REG2, the primary component 70 is a LM2734 PWM step down DC-DC regulator from National Semiconductor, generating V_{CC} of 3.3 V. In REG1, the primary component 72 is an Ultralow-Noise, High-PSRR, Fast, RF, 250-mA Low-Dropout TPS70401 Linear Regulator from Texas Instruments of Dallas, Tex., generating V_{CORE} of 1.8 V.

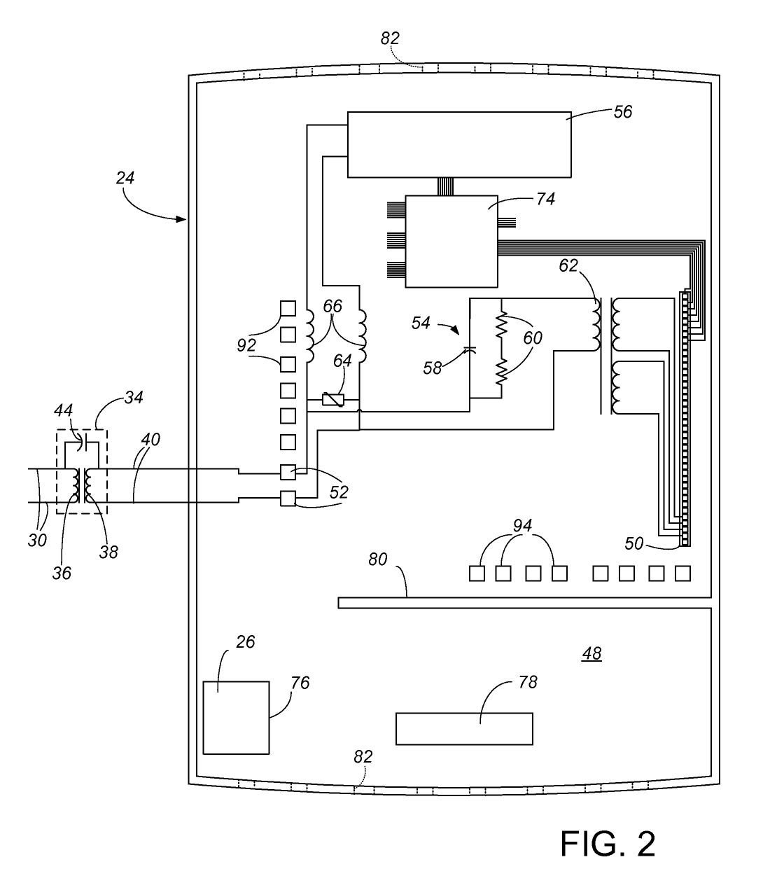

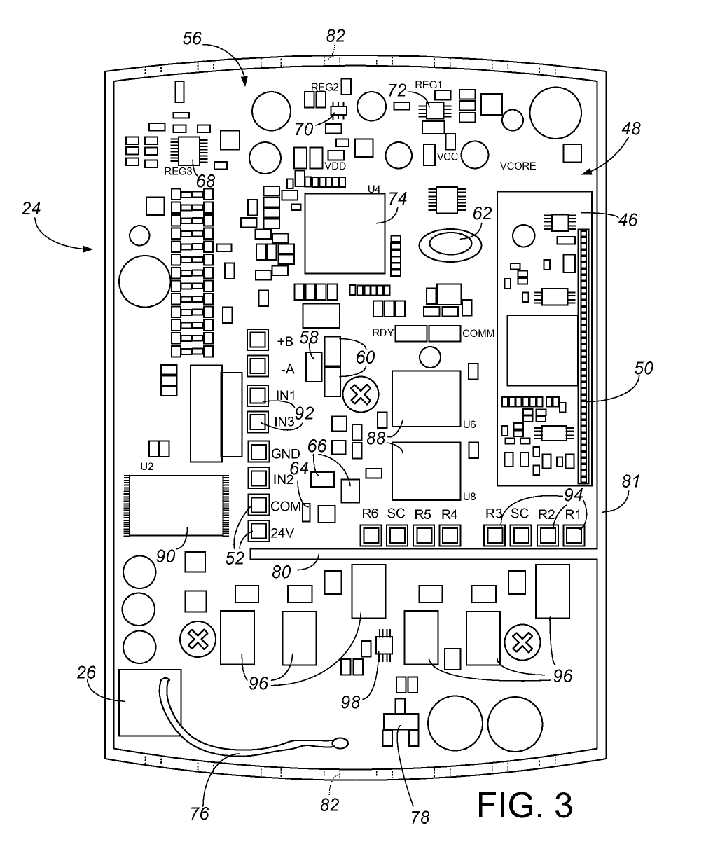

The PLC signal on the incoming 24V AC power line 40 causes the power circuits 56 and the powerline signal coupler 62 to generate heat which, unless otherwise adjusted for, can be sensed by the temperature sensor 26. As best shown in FIGS. 2 and 3, the power circuits 56 of the transmitter are located on the top of the circuit board 48, above the main microprocessor 74. The powerline signal coupler 62 is located relatively high on the circuit board 48 but beneath the power circuits 56. At the same time, the temperature sensor 26, and the optional humidity sensor 76 and occupancy sensor 78, are located on the bottom of the circuit board 48. This layout helps avoid misreadings because the heat rises from the power circuits 56 and powerline signal coupler 62 away from the temperature sensor 26 and optional humidity sensor 76.

A heat channeling separation wall 80 is located in the housing 81 of the thermostat 24. Vents 82 are provided in the lower and upper walls of the housing 81. The vents 82 and separation wall 80 direct heat generated by the electronics to ambient air, away from the on-board room temperature sensor 26 and optional humidity and occupancy sensors 76, 78. The use of this embedded thermal venting channel increases the accuracy of the sensing elements 26, 76, 78, allowing closer control of the affected spaces. The preferred housing 81 is about 4 inches wide, 5½ inches tall and 1½ inches deep, with the separation wall 80 extending about three fourths of the way across the housing 81 from left to right as view from the front (FIGS. 2 and 3 are rear views). The preferred vents 82 are about 24 holes of about ¼ inch diameter in the top and bottom walls of the housing 81.

A user interface 84 on the front face of the thermostat 24 allows the user to read and set various functions within the control program. The preferred user interface 84 and standard thermostat control program are similar to those of the FLEXSTAT programmable thermostat of KMC Controls, Inc. of New Paris, Ind., assignee of the present invention. In particular, the preferred input mechanism 86 utilizes a five button control. This input mechanism 86 not only allows configuration of standard thermostat functions (such as temperature set point), but also allows configuration of which HVAC actions will take place in which order in response to the various commands or data provided by the utility 10. The user interface 84 also includes a high-contrast backlit dot matrix LCD display 28 (68×128 pixel) similar to the FLEXSTAT programmable thermostat 24. The control program is stored on one or more memory chips 88, 90 and carried out on a primary microprocessor 74 chip for the thermostat 24. The preferred embodiment uses a MCF5274L microprocessor 74 from Freescale Semiconductor of Austin, Tex., in conjunction with two 32 MB flash memory chips 88 and an 8 MB SRAM chip 90. Other standard circuits, such as clock circuits, watchdog circuits, EEPROM circuits, debugging circuits, power back up circuits, etc. (not separately called out) can also be included on the circuit board 48.

As known in the programmable thermostat art, the thermostat 24 can optionally include additional inputs 92 for use by the control program and additional outputs 94 operated by the control program. Relays 96 for the outputs 94 are used to automatically turn on or off other connected loads in response to a pre-programmed, but configurable “demand response” or “power shedding” program. Common applications for the additional outputs 94 are the retrofit of existing pneumatic VAV terminals, fan coil units, and water source heat pumps in buildings where power is already present at the controlled terminal unit, but digital controls were not used during the initial installation. Typically the inputs 92 receive 0-12V analog signals, but other settings for the inputs 92 could be used. Typically the outputs 94 can provide analog signals 0-12V, maximum 20 mA or digital signals through the relays 96 of 1 A per relay 96, 1.5 A total for banks of three relays 96 at 24 VAC/VDC, but other settings for the outputs 94 could alternatively be provided.

In the preferred embodiment, the user interface 84 allows access to and display of a menu driven control program permitting entry of instructions and display of data. In particular, the data and settings in the control program include but are not limited to:
a. Normal permissible daily operating schedules and temperature setpoints for connected HVAC equipment. The thermostatic functions may be programmed by the owner to automatically set up and setback operating HVAC setpoints during the day as is commonplace with residential programmable thermostats, which may include scheduled “occupied” and “unoccupied” modes, and scheduled daytime and nighttime modes.
b. When the thermostat 24 is provided with the optional occupancy sensor 78, the control program adaptively learns the occupancy schedule of the connected space and automatically reduces energy consumption of connected loads in the HVAC system 14 accordingly.
c. Display of current energy usage conditions of the connected HVAC equipment, such as current Kw and KWH consumed.
d. Command status “event” information transmitted and received from the utility company 10, such as “normal” operation, “alert” status for a pending demand response event, and one or more indications of a “shed” status of the various utility thresholds.
e. Projected current cost of operation during the event in currency/hour rate measurements, based upon the event status and the current energy usage information, as well as accumulated cost data.
f. Operating conditions of any other connected energy management loads controlled by the thermostat 24 (such as On/Off control of other loads such as televisions 100, lights 102, pool pumps (not shown), electric hot water heaters (not shown), dryers (not shown), etc.) via the “relay” type outputs 94 or via instructions transmitted from the PLC module 46.
   The thermostat 24 provides rapid system response (typically less than 3 seconds) to a command from the utility 10 for near “real-time” display and update of connected load and utility data information.

The thermostat 24 can transmit thermostat information to the utility 10, such as sensed temperature and temperature set point. The thermostat 24 also transmits a response to the utility 10 of actions taken in order to let the utility grid control system get closed loop feedback for management of overall grid electrical loads in a wide geographic area when many of these systems are deployed on a large scale. In the preferred embodiment, both the utility PLC information and the thermostat PLC information are sent in conformance with UtilityAMI standards.

With the utility event status information received at the thermostat 24 and the thermostat information received at the utility 10, the present invention allows control strategies that are not available in simple smart meter installations, even if such smart meters are programmable. The thermostat 24 allows adjusting heating and cooling setpoints of the HVAC system 14 to immediately turn off the connected compressor, heating, and fan loads while providing a minimum level of comfort and/or safety protection by only allowing the temperature to “float” within specified minimum and maximum values. For instance, during a “shed” event, the sensed temperature of indoor spaces can be used in establishing the control strategy, such as with the system allowing full HVAC power to spaces having a temperature of greater than 82° F., or with a sensed temperature/set point differential of greater than 5° F.

The utility company 10 and/or the user can establish numerous different complex “shed” protocols, such as shed protocols based upon the temperature and/or humidity differential between exterior conditions and interior conditions at each residence. If occupancy information is transmitted, the utility's “shed” strategy can be directed more to unoccupied spaces. The utility company 10 can also make a real time estimate the amount of load reduction which will be obtained which each different “shed” strategy, to better decide which “shed” strategy to pursue for each peak demand event. The feedback annunciation of control actions within the building 12 to the utility 10 enables the utility 10 to improve its forecasting strategy for each different type of demand event, enabling the utility 10 to fine tune its various array of “shed” strategies based upon real-time building-specific information. The real costs of the utility company 10 can be more directly and equitably bourn by the various utility customers, and power used more efficiently by the entire system.

In addition to the outputs 96 directly controlled by the thermostat 24, the thermostat 24 optionally may be used to communicate with other devices on the building's 120V AC power lines 30, if such other devices are similarly configured with PLC receivers. For instance, other electricity consuming devices such as a television 100, electric clothes dryer or dishwasher (not shown) may have a PLC receiver configured to receive a signal generated by the thermostat 24 and transmitted through the 24V AC power line 40 and HVAC system transformer 34. Then the control program may turn off various loads throughout the building 12 as selected by the resident in response to the rising price of electricity and/or status signals sent by utility 10, such as
a. In response to a first “shed” condition signal from the utility 10, turn off a connected swimming pool circulating pump (not shown) via a commanded relay output, and adjust HVAC setpoints in unoccupied spaces.
b. In response to a second “shed” condition signal from the utility 10, adjust HVAC setpoints in occupied spaces.
c. In response to a third “shed” condition signal from the utility 10, reduce other appliance loads such as commanding a TV 100 into standby mode via an addressable wall socket,
d. In response to a fourth “shed” condition signal from the utility 10, turn off lights 102 depending on the time of day, or turn off an electric hot water heater (not shown) depending on the time of day and outside temperature, via a commanded relay.
e. In response to a fifth “shed” condition signal from the utility 10, command a running electric dryer or dishwasher (not shown) to complete their operating heating cycle and then go to a “safe” operating mode as determined by the appliance manufacturer by sending a command to the addressable microcomputer located in the device.

Of course, the thermostat 24 also operates in a “normal” mode for the user to control the energy usage within the home during standard operating conditions that occur when the utility 10 is not in a “shed” command mode. In the “normal” mode, the scheduling functions of the control program are extended to the outputs and to any other connected electrical loads throughout the home via the addressable PLC capability, enabling the user to schedule electrical energy usage during either “off-peak” electrical rate periods, “time of day” periods, while the occupancy sensor 78 determines that no one is present, or any combination thereof. In addition, the scheduling functions are extended to other connected electrical loads throughout the home via the addressable device capability or other directly connected loads to schedule electrical energy usage during either “off-peak” electrical rate periods, while the homeowners may or may not be present, or both. This capability further allows the user to use the thermostat control program to minimize consumer energy costs.

If desired, the thermostat 24 may have other communication structures which allow the control program to be set in ways in addition to the user interface 84. For instance, the preferred thermostat 24 has a RS 485 chip 98 and connection (not shown, provided on bottom wall of housing) permitting a computer connection directly to the thermostat 24 via an RS 485 cable. As another additional optional example, the thermostat 24 may transmit on the 24V AC line 40 through the HVAC system transformer 34, to be read by a commercially available powerline-to-Ethernet transceiver (not shown) plugged into a wall socket in the building 12 and then to a commercially available Ethernet hub, switch, or router (not shown). As a third additional optional example, the thermostat 24 may include an Ethernet “RJ-45” connection (not shown) that allows a conventional Ethernet cable to connect from the wall controller location to a computer or to a commercially available Ethernet hub, switch, or router device (not shown). As a fourth additional optional example, the thermostat 24 may have an Ethernet speed (>1 Mbps) capable 2-way radio transceiver (not shown) that provides 2-way wireless communication from the thermostat 24 to a wirelessly transmitting computer in the vicinity.

With any one or more of these additional communication structures, the thermostat microprocessor 74 and memory chips 88, 90 contains and operates an embedded HTML web service with graphical display application. The web service function serves up graphically displayed web pages to provide viewing via an internet browser such as Internet Explorer or Firefox. If communicating over the internet, access to the control program is password protected. The user has 2-way data exchange with these web pages and may use them to view current operating conditions on the webpage, to override utility demand response commands, and to change normal operational conditions such as setpoints, schedules, and demand response priorities. The web pages also graphically display energy use information for the user in a formatted, easy to use manner.

The complete integrated residential home energy management system consists of the thermostat 24 and its resident software, firmware, application control sequences and algorithms, the HVAC system transformer 34, connected HVAC electricity-consuming components 16, and other electricity-consuming loads within a typical building 12. The invention specifically provides control of the energy usage within the home in response to 2-way utility command and control signals and messages found within the “Smart Grid” environment of modern electrical utilities to help utilities manage system electrical demand across a wide geographic area. The system embodies a complete process of operating in a variety of normal and electricity “shed” modes to minimize the energy usage within the building 12.

Although the present invention has been described with reference to preferred embodiments, workers skilled in the art will recognize that changes may be made in form and detail without departing from the spirit and scope of the invention.

1. A distributed power line communicating thermostat control system comprising:
a HVAC system transformer adapted for lowering primary alternating current power voltage within a building to secondary alternating current power voltage for an HVAC system, the transformer having a primary winding and a secondary winding;
a capacitor electrically connected across the primary winding and secondary winding of the HVAC system transformer, the capacitor assisting in analog transference of a power line communication radio frequency signal across the HVAC system transformer;
a programmable thermostat electrically connectable to the HVAC system transformer for being powered by the secondary alternating current power voltage at a distributed distance from the HVAC system transformer; the programmable thermostat comprising:
a power line communication reception/transmission system for receiving the power line communication radio frequency signal from the secondary alternating current power voltage lines and for deriving control instructions from the received power line communication radio frequency signal, and for transmitting a radio frequency response signal onto the secondary alternating current power voltage lines based upon response information; and
a control processor programmed to change thermostat functions based upon control instructions from the power line communication reception system, the control processor also programmed to provide response information to the power line communication reception/transmission system.

2. The distributed power line communicating thermostat control system of claim 1, wherein the programmable thermostat further comprises:
a temperature sensor providing a sensed temperature value to the control processor, wherein the temperature sensor, the control processor, power circuits for the programmable thermostat and the power line communication reception/transmission system are mounted in a housing, with the temperature sensor positioned in the housing lower than the control processor, the power circuits and the power line communication reception/transmission system so as to sense ambient air temperature while minimizing error introduced from heat generated by the control processor, the power circuits and the power line communication reception/transmission system.

3. The distributed power line communicating thermostat control system of claim 1, wherein the programmable thermostat further comprises:
a humidity sensor providing a sensed humidity value to the control processor, wherein the humidity sensor, the control processor, power circuits for the programmable thermostat and the power line communication reception/transmission system are mounted in a housing, with the humidity sensor positioned in the housing lower than the control processor, the power circuits and the power line communication reception/transmission system so as to sense ambient air humidity while minimizing error introduced from heat generated by the control processor, the power circuits and the power line communication reception/transmission system.

4. The distributed power line communicating thermostat control system of claim 1, wherein the programmable thermostat further comprises:
an occupancy sensor providing a sensed occupant result to the control processor.

5. The distributed power line communicating thermostat control system of claim 4, wherein the programmable thermostat transmits occupancy information onto the secondary alternating current power voltage lines.

6. The distributed power line communicating thermostat control system of claim 1, wherein the capacitor has a capacitance of 50 to 10000 pico farads.

7. The distributed power line communicating thermostat control system of claim 1, wherein the capacitor has a capacitance of 500 to 1000 pico farads.

8. The distributed power line communicating thermostat control system of claim 1, wherein the secondary alternating current power voltage is at 24 volts.

9. The distributed power line communicating thermostat control system of claim 1, wherein the control instructions are Utility AMI instructions.

10. The distributed power line communicating thermostat control system of claim 1, wherein the programmable thermostat provides one or more output terminals for controlling HVAC equipment.

11. The distributed power line communicating thermostat control system of claim 1, wherein the programmable thermostat provides one or more input terminals for receiving HVAC information signals.

12. The distributed power line communicating thermostat control system of claim 1, wherein the response information comprises actions taken by the programmable thermostat in response to a shed condition provided in real time by the programmable thermostat.

13. The distributed power line communicating thermostat control system of claim 1, wherein the programmable thermostat transmits sensed temperature information onto the secondary alternating current power voltage lines.

14. The distributed power line communicating thermostat control system of claim 1, wherein the programmable thermostat transmits temperature set point information onto the secondary alternating current power voltage lines.

15. A power line communicating programmable thermostat comprising:
a power line communication reception/transmission system for receiving the power line communication radio frequency signal on low voltage lines and for deriving control instructions from the received power line communication radio frequency signal, and for transmitting a radio frequency response signal onto the secondary alternating current power voltage lines based upon response information;
a temperature sensor;
an output for controlling HVAC equipment;
a control processor programmed to change thermostat functions based upon sensed temperature and based upon control instructions from the power line communication reception system, the control processor also programmed to provide response information to the power line communication reception/transmission system; and
power circuits for the programmable thermostat, the power circuits operating on a HVAC system voltage less than 120 volts, wherein the temperature sensor, the control processor, power circuits for the programmable thermostat and the power line communication reception/transmission system are mounted in a housing, with the temperature sensor positioned in the housing lower than the control processor, the power circuits and the power line communication reception/transmission system so as to sense ambient air temperature while minimizing error introduced from heat generated by the control processor, the power circuits and the power line communication reception/transmission system.

16. The power line communicating programmable thermostat of claim 15, further comprising:
a humidity sensor providing a sensed humidity value to the control processor, the humidity sensor being mounted in the housing, with the humidity sensor positioned in the housing lower than the control processor, the power circuits and the power line communication reception/transmission system so as to sense ambient air humidity while minimizing error introduced from heat generated by the control processor, the power circuits and the power line communication reception/transmission system.

17. The power line communicating programmable thermostat of claim 15, further comprising:
an occupancy sensor providing a sensed occupant result to the control processor, wherein the programmable thermostat transmits occupancy information using the power line communication reception/transmission system.

18. The power line communicating programmable thermostat of claim 15, wherein the programmable thermostat transmits sensed temperature information using the power line communication reception/transmission system.

19. The power line communicating programmable thermostat of claim 15, wherein the programmable thermostat transmits temperature set point information using the power line communication reception/transmission system.

20. The power line communicating programmable thermostat of claim 15, wherein the housing comprises a heat channeling separation wall above the temperature sensor and below the control processor, the power circuits and the power line communication reception/transmission system.
